(19) United States
(12) Patent Application Publication
(10) Pub. No.: US 2010/0263852 A1
(43) Pub. Date: Oct. 21, 2010

(54) HEAT MANAGEMENT FOR ENCLOSED ELECTRONICS

(75) Inventors: Frank Mirshams, San Jose, CA (US); Gary Wong, Pleasanton, CA (US); Michael Nguyen, Milpitas, CA (US); Nozar Azarakhsh, Modesto, CA (US)

Correspondence Address: PERKINS COIE LLP, P.O. BOX 1208, SEATTLE, WA, 98111-1208, US

(73) Assignee: Trapeze Networks, Inc., Pleasanton, CA (US)

(21) Appl. No.: 12/427,715

(22) Filed: Apr. 21, 2009

(51) Int. Cl. F24F 11/053; G05D 23/19

(52) U.S. Cl. 165/247; 165/244; 165/260; 700/278

(57) ABSTRACT

Providing a plurality of fans within an enclosure. A system implementing this technique can include an enclosure, a heat sink in thermal communication with the enclosure, electronic components at least partially sealed within the enclosure, an eXclusive OR (XOR) fan array, a monitoring engine, and a control engine. A method implementing this technique can include using a heat sink to dissipate heat generated by electronic components within an enclosure; determining that each of the fans of a XOR fan array are stopped, selecting one and only one of the fans of the XOR fan array for operation, and operating the fan to increase air flow within the enclosure, thereby increasing the efficiency of the heat sink.

### BACKGROUND

Heat management is a problem in enclosed electronics systems. However, an enclosure is frequently necessary. For example, an electronics system might be deployed outside, making it important to protect the electronics from the environment by placing the electronics inside an enclosure or housing. In operation, the electronics generate heat, which increases the temperature inside the housing relative to the ambient temperature. It is well-known that increases in temperature can reduce the lifespan of electronics.

Some manufacturers attempt to solve the problem of heat management for enclosed electronics by putting a fan inside the enclosure. This offers some temporary improvement, but the fan typically fails before the end of the lifespan of the electronics is reached. An enclosed electronics unit with a non-functional fan can quickly reach temperatures that are harmful to the electronics, causing the unit to fail shortly after the fan fails.

Heat management for enclosed electronics is an active area of research.

### SUMMARY

A technique for heat management for enclosed electronics involves providing an eXclusive OR (XOR) fan array within an enclosure. A system implementing this technique can include an enclosure, a heat sink in thermal communication with the enclosure, electronic components at least partially sealed within the enclosure, a XOR fan array having a plurality of fans, a monitoring engine, and a control engine. A method implementing this technique can include using a heat sink to dissipate heat generated by electronic components within an enclosure, determining that each of the fans of a XOR fan array are stopped, selecting one and only one of the fans of the XOR fan array for operation, and operating the fan to increase air flow within the enclosure, thereby increasing the efficiency of the heat sink.

### BRIEF DESCRIPTION OF THE DRAWINGS

FIG. 1 depicts an example of a heat management system for enclosed electronics.

FIG. 2 depicts a flowchart of an example of a method for heat management for enclosed electronics.

FIG. 3 depicts an example of a wireless access point with XOR fan array.

FIG. 4 depicts a conceptual diagram of a corner XOR fan array configuration.

FIG. 5 depicts a conceptual diagram of a side XOR fan array configuration.

FIG. 6 depicts a conceptual diagram of a full coverage XOR fan array configuration.

### DETAILED DESCRIPTION

Techniques for heat management of enclosed electronics are described. References in this specification to “an embodiment”, “one embodiment”, or the like, describe an example of feature, structure or characteristic. Occurrences of such phrases in this specification do not necessarily all refer to the same embodiment.

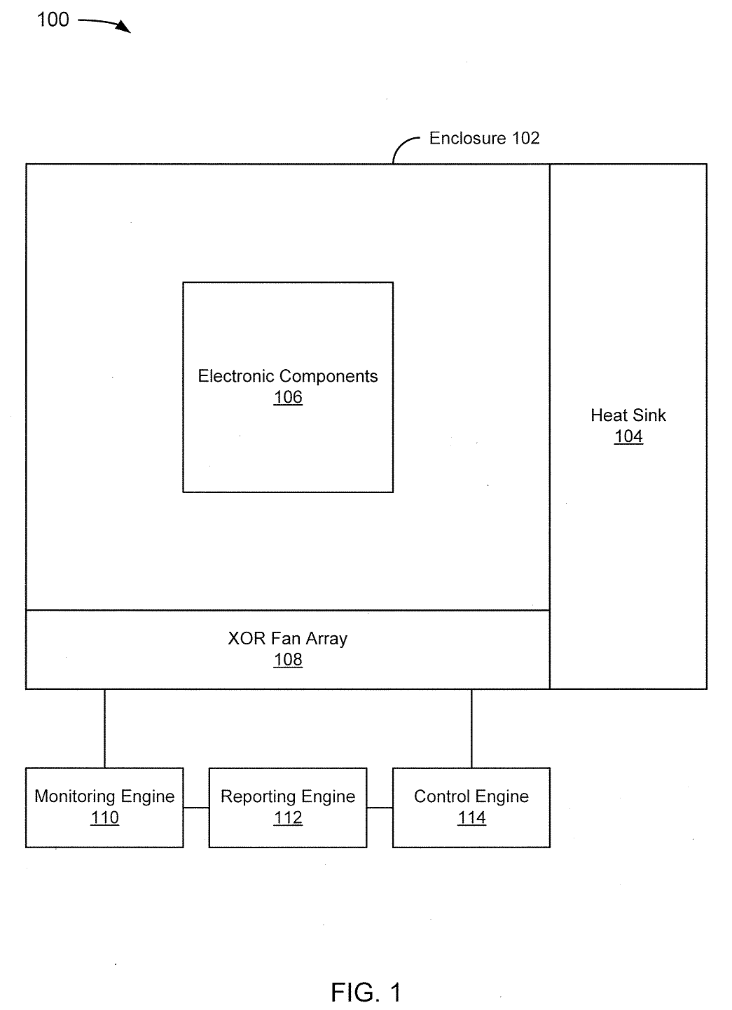

FIG. 1 depicts an example of a heat management system 100 for enclosed electronics. The system 100 includes an enclosure 102, a heat sink 104, electronic components 106, an eXclusive OR (XOR) fan array 108, a monitoring engine 110, a reporting engine 112, and a control engine 114.

In the example of FIG. 1, the enclosure 102 is a barrier that reduces or prevents the flow of air from outside (ambient) to components within the enclosure (internal components). An enclosure can be used to protect internal components from the environment. By way of example but not limitation, the enclosure could be for a wireless access point (AP) that is located outside, making it desirable to protect the internal components from, e.g., the weather. Enclosures can also be designed to protect the environment from the internal components. By way of example but not limitation, a cell phone could include electronic components that become hot to the touch, and an enclosure around the electronic components of the cell phone could protect humans who carry the cell phone from discomfort or harm. Enclosures can also be used to make electronics more aesthetically pleasing. By way of example but not limitation, a computer might be fully functional with electronic components hanging outside of a housing, but customers might want and expect the electronic components to be contained within a reasonably aesthetically pleasing enclosure. The reasons to use an enclosure vary, but these examples should serve to explain at least some.

In the example of FIG. 1, the heat sink 104 is coupled to the enclosure 102. Although the heat sink 104 is depicted as distinct from the enclosure 102, the heat sink can be “inherent” in the enclosure 102. That is, the enclosure 102 itself can have heat dissipation capabilities, and no separate and distinct heat sink 104. It is also possible for the enclosure 102 to have heat dissipation capabilities, and still have a distinct heat sink 104, presumably providing even more improved heat dissipation capabilities. As used in this paper, when the heat sink 104 is described as being “in thermal communication with” the enclosure 102, it is intended to mean that the enclosure 102 has an inherent heat sink, or is operationally connected to a distinct heat sink.

In the example of FIG. 1, the electronic components 106 are at least partially sealed within the enclosure 102. It is expected that in many implementations, the electronic components 106 are connected to the enclosure 102 for, e.g., stability. However, it is not required that the electronic components 106 actually be connected to the enclosure 102. Also, the electronic components 106 may or may not be connected to the heat sink 104. Since the electronic components 106 are inside the enclosure 102, it is relatively safe to assume that the electronic components 106 are coupled, at least indirectly, to the enclosure 102. In some unusual cases, for example if the electronic components 106 are kept from touching the enclosure 102 by using magnets to keep them from touching anything, the electronic components 106 might not be coupled to the enclosure 102, but this is expected to be rare. A likely implementation would have the electronic components 106 coupled to and in thermal communication with the enclosure 102, and the enclosure 102 coupled to and in thermal communication with the heat sink 104.

For illustrative purposes, it is assumed that the electronic components 106 are at least partially sealed within the enclosure 102. This assumption is made because the techniques provided in this paper are most effective when the electronic components 106 increase the temperature within the enclosure 102. If the electronic components 106 were not at least partially sealed within the enclosure 102, then the electronic components 106 would presumably not substantially increase the temperature within the enclosure 102, rendering the examples in this paper moot. Also, one reason for heat management is to prevent the electronic components 106 from becoming too hot, but if the electronic components 106 are not at least partially enclosed within the enclosure 102, then managing heat within the enclosure 102, at least with respect to the electronic components 106, would be moot.

In the example of FIG. 1, the XOR fan array 108 includes a plurality of fans. A XOR fan array is defined to be a fan array that can (either through configuration or hardwired restrictions) have only one fan running at a time. The XOR fan array 108 is expected, at least initially, to be configured with the plurality of fans operational, though throughout the lifespan of the XOR fan array 108, under appropriate conditions, it is expected that one or more of the fans may become inoperable. However, only one of the plurality of fans is intended to operate at any given time, regardless of whether other of the plurality of fans are operable. Advantageously, since only one of the fans of the XOR fan array 108 is operating at a time, the XOR fan array 108 is expected to have a longer lifespan than a fan array that has either a single fan (i.e., an “array” of one fan) or multiple fans operating simultaneously. Moreover, a surprising result of experimentation has shown that running multiple fans does not help at high temperatures because, it seems, air flow reaches equilibrium. It should be noted that the XOR fan array 108 could be one of a plurality of fan arrays (not shown), where each of the plurality of fan arrays have a maximum of one fan operating at a time.

For illustrative purposes, it is assumed that the XOR fan array 108 is in fluid communication with the enclosure 102. This assumption is made because a fan of the XOR fan array 108 is intended to increase air flow within the enclosure 102. Thus, as used in this paper, “in fluid communication with the enclosure” is intended to mean “capable of increasing air flow within the enclosure.” Advantageously, if the XOR fan array 108 is at least partially sealed within the enclosure 102, the XOR fan array 108 can benefit from the protection (or, e.g., aesthetics) of the enclosure 102, just as the electronic components 106 do. Presumably, in this case, the increase in air flow will be more advantageous for heat dissipation purposes than the increase in temperature that might be caused by operating a fan within the enclosure 102.

In the example of FIG. 1, the monitoring engine 110 is coupled to the XOR fan array 108. For illustrative purposes, the monitoring engine 110 is coupled to the XOR fan array 108 because a minimalist monitoring engine 110 could be designed to detect only whether a fan of the XOR fan array 108 is currently operating. Thus, the monitoring engine 110 could monitor tach output, motion sensor output, voltage differential, or other characteristics that are useful for determining whether a fan of the XOR fan array 108 is currently operating. The monitoring engine 110 can be referred to as including the device that performs the monitoring (e.g., a motion sensor) or as coupled to the device. For illustrative simplicity, it is assumed that all such devices are included in the monitoring engine 110. Thus, although the monitoring engine 110 is depicted as a discrete box in the example of FIG. 1, it should be understood that it can be distributed throughout the system 100. An implementation in which the monitoring engine 110 simply monitors fan revolutions is sufficient to take advantage of techniques described in this paper. However, depending upon the implementation, the monitoring engine 110 can be used to monitor any known or convenient characteristic, such as conditions within the enclosure 102 (e.g., temperature, humidity, vibration, etc.), outside the enclosure 102, or in association with the electronic components 106 (e.g., voltage, radio frequency (RF) signals, etc.).

As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

In the example of FIG. 1, the reporting engine 112 is coupled to the monitoring engine 110. In a minimalist implementation, where the monitoring engine 110 simply provides data associated with whether a fan of the XOR fan array 108 is operating, communications from the reporting engine 112 may or may not be relatively local. For example, all of the components depicted in the example of FIG. 1 could be part of a stand-alone system that does not report back to “control;” all functionality can be carried out locally.

In other implementations, even if the implementation is minimalist, the reporting engine 112 could be coupled to non-volatile storage (NVS) that saves data for, to list a couple of examples, routine status checks by an engineer or for troubleshooting if the system 100 fails. In an implementation that includes NVS, the NVS can be considered “part of” the reporting engine 112.

In other implementations, even if the implementation is minimalist, the reporting engine 112 could be coupled to a network (not shown) and send reports over the network. It may be desirable to send data associated with the enclosure 102 to a relatively remote “control” computer system via a network connection to enable a human or artificial agent to monitor the heat management system 100 remotely. In an implementation that includes a network, a network interface can be considered “part of” the reporting engine 112. A relatively remote computer system that receives reports from the reporting engine 112 could be referred to as coupled to the reporting engine 112 or it could itself be considered part of the reporting engine 112. For the purposes of this paper, it is assumed that the relatively remote computer system is part of the reporting engine 112 if both the reporting engine 112 and the relatively remote computer system are under the control of a single entity or mastermind. Similarly, for the purposes of this paper, a portion of the network can be considered part of the reporting engine 112 if both the reporting engine and the portion of the network are under the control of a single entity or mastermind. Otherwise, the reporting engine 112 is referred to as coupled to the network.

A network, as used in this paper, can include a networked system that includes several computer systems coupled together, such as a Wireless Local Area Network (WLAN) or the Internet. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art. For illustrative purposes, it is assumed a network broadly includes, as understood from relevant context, anything from a minimalist coupling of components, to every known or convenient network in the aggregate.

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor.

The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The bus can also couple the processor to the interface. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

In one example of operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs to configure the general purpose systems in a specific manner in accordance with the teachings herein, or it may prove convenient to construct specialized apparatus to perform the methods of some embodiments. The required structure for a variety of these systems will appear from the description below. In addition, the techniques are not described with reference to any particular programming language, and various embodiments may thus be implemented using a variety of programming languages.

Referring once again to the example of FIG. 1, the control engine 114 is coupled to the reporting engine 112 and the XOR fan array 108. In a minimalist implementation, the control engine 114 has a single function: to select one and only one fan for operation if the reporting engine 112 provides data that suggests no fan is currently operating. The selection can be communicated to the XOR fan array 108 in any applicable convenient manner, but for illustrative purposes, the communication is referred to as providing a control signal to the XOR fan array 108 to cause one and only one of the plurality of fans of the XOR fan array 108 to begin operating. It is likely that temperature data would also be deemed useful. If temperature is a characteristic that can be detected by the monitoring engine 110, the control engine 114 may opt, for example, to make no fans operational when the temperature is sufficiently low within the enclosure 102. The control engine 114 could have additional functionality to shut down or reset the electronic components 106 and/or the XOR fan array 108, for example, if a temperature within the enclosure 102 is too high.

In the example of FIG. 1, in operation, the electronic components 106 generate heat, making a temperature within the enclosure 102 higher than a temperature outside the enclosure 102, and the heat sink 104 dissipates at least some of the heat to outside. The monitoring engine 110 obtains data at least sufficient to determine whether each of the plurality of fans of the XOR fan array 108 are stopped, such as through tach output that detects whether a fan is spinning. The reporting engine 112 provides the data at least sufficient to determine whether each of the plurality of fans of the fan array are stopped to the control engine 114. The reporting engine 112, depending upon the implementation, may provide additional data to the control engine 114, or to some other component, system, or engine.

The control engine 114 determines whether all fans of the XOR fan array 108 are stopped. If all of the fans of the XOR fan array 108 are stopped, and increased heat dissipation is desired, the control engine 114 chooses a single fan to start operating. When increased heat dissipation is desired, the fan array can be referred to as in an increased heat dissipation desired mode. It may be noted that in a minimalist implementation, and perhaps other implementations as well, increased heat dissipation can be assumed to be desired whenever all of the fans of the XOR fan array 108 are stopped. In such an implementation, the fan array can be referred to as permanently set to increased heat dissipation desired mode.

If all of the fans of the XOR fan array 108 are stopped, and increased heat dissipation is not desired (assuming this is possible in a given implementation), the control engine 114 can select none of the fans to start operating. If one of the fans of the XOR fan array 108 is operating, and decreased air flow is determined to be acceptable, the control engine 114, depending upon implementation, can turn the fan off. If one of the fans of the XOR fan array 108 is operating, and decreased air flow is determined to be unacceptable, the control engine 114 can, depending upon implementation, do nothing, reselect the fan that is currently operating, or turn of the currently operating fan in favor of some other fan of the XOR fan array 108. It may be noted that in a minimalist implementation, and perhaps in other implementations as well, decreased air flow can be assumed to be unacceptable whenever a fan is operating.

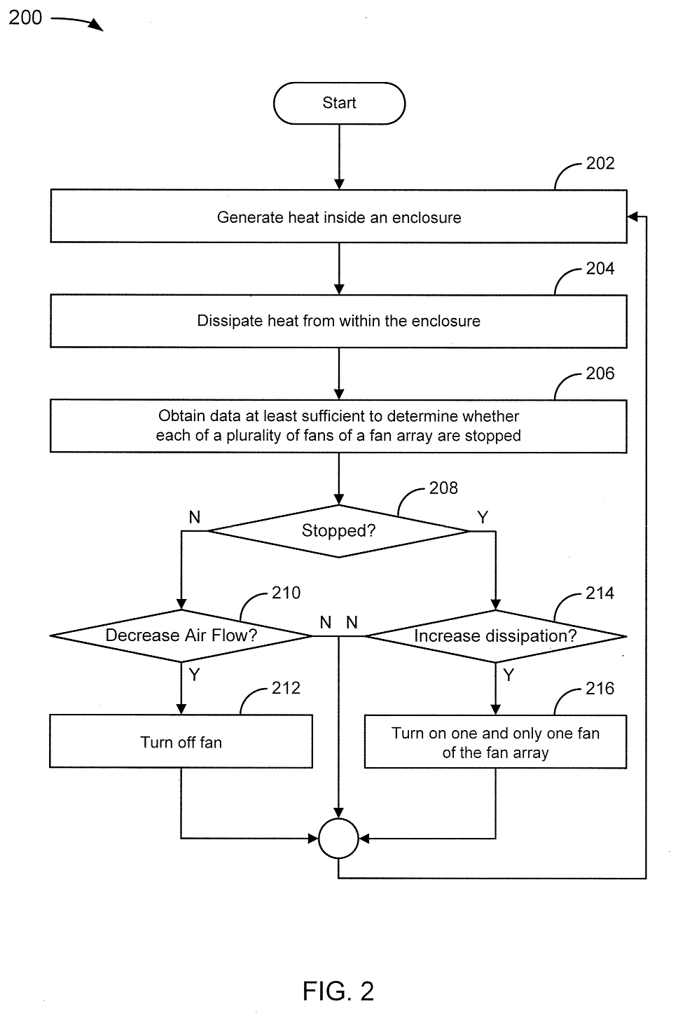

FIG. 2 depicts a flowchart 200 of an example of a method for heat management for enclosed electronics. The method is organized as a sequence of modules in the flowchart 200. However, it should be understood that these and other modules associated with other methods described herein may be reordered for parallel execution or into different sequences of modules. In one implementation, at least part of the method can be performed by computer logic that may comprise hardware (e.g., special-purpose circuitry, dedicated hardware logic, programmable hardware logic, etc.). In another implementation, at least part of the method can also be implemented in software (such as instructions that can be executed on a processing device), firmware or a combination thereof embedded in hardware components. In another implementation, machine-executable instructions for the method can be stored in memory and executed by a processor.

In the example of FIG. 2, the flowchart 200 starts at module 202 where heat is generated inside an enclosure. The heat can be generated by, for example, electronics components. Heat could also be generated from sunlight on the outside of the enclosure.

In the example of FIG. 2, the flowchart 200 continues to module 204 where heat is dissipated from within the enclosure. Generally, a heat sink dissipates heat. The enclosure itself could act as a heat sink.

In the example of FIG. 2, the flowchart 200 continues to module 206 where data at least sufficient to determine whether each of a plurality of fans of a fan array are stopped is obtained. Other data could be obtained, as well.

In the example of FIG. 2, the flowchart 200 continues to decision point 208 where it is determined whether each of the plurality of fans of the fan array are stopped. If it is determined that a fan of the fan array is running (208-N) then the flowchart 200 continues to decision point 210 where it is determined whether decreased air flow is acceptable. If it is determined that decreased air flow is not acceptable (210-N) then the flowchart 200 returns to module 202 and continues as described previously. Presumably, the fan that was running continues running, though it is also possible to switch from the fan that was running to a different fan. If, on the other hand, it is determined that decreased air flow is acceptable (210-Y) then the flowchart 200 continues to module 212 where the fan is turned off and the flowchart returns to module 202 and continues as described previously.

If it is determined that each of the plurality of fans of the fan array are stopped (208-Y), then the flowchart 200 continues to decision point 214 where it is determined whether increased heat dissipation is desired. If it is determined that increased heat dissipation is not desired (214-N) then the flowchart 200 returns to module 202 and continues as described previously. If, on the other hand, it is determined that increased heat dissipation is desired (214-Y) then the flowchart 200 continues to module 216 where one and only one fan of the fan array is turned on and the flowchart 200 returns to module 202 and continues as described previously.

It may be noted that a fan of the fan array may start running at the outset (e.g., the fan array begins running immediately upon installation or power up) or a fan of the fan array may start running later after it is determined that increased heat dissipation is desired at decision point 214. In theory, the flowchart 200 need not end, though in practice any device is likely to be taken off line at some point, at the very least when it ceases to function.

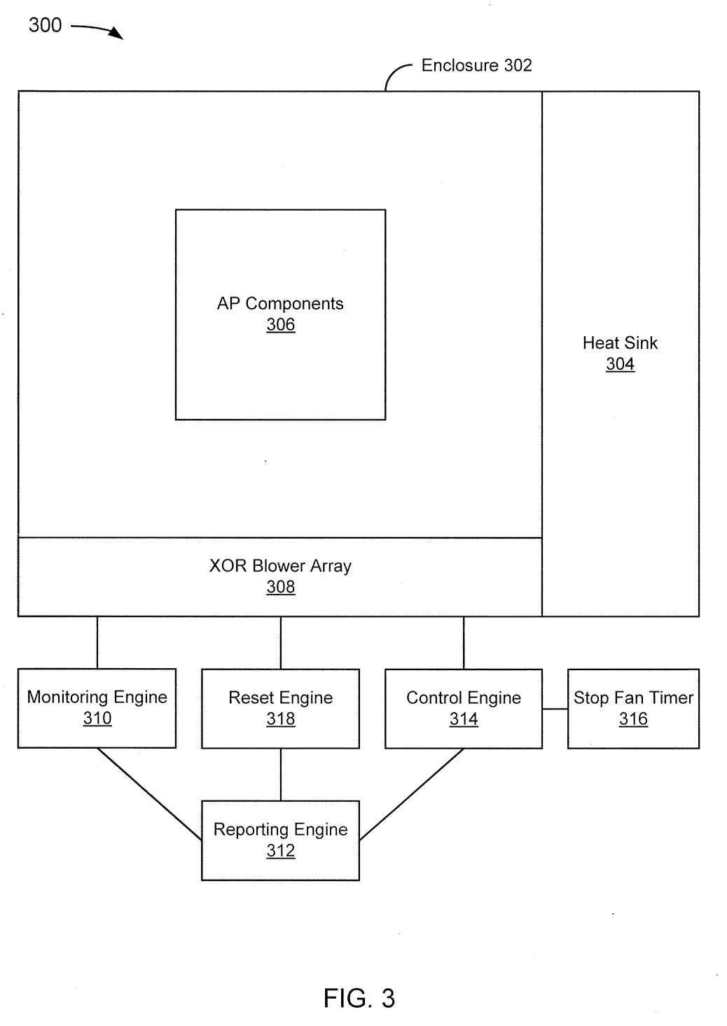

FIG. 3 depicts an example of a wireless access point (AP) 300 with eXclusive OR (XOR) blower array. The AP 300 includes an enclosure 302, a heat sink 304, AP components 306, a XOR blower array 308, a monitoring engine 310, a reporting engine 312, a control engine 314, a stop fan timer 316, and a reset engine 318.

An AP is chosen for the example of FIG. 3 because of some interesting characteristics that APs and certain other electronic devices have. One interesting characteristic is APs can be designed for indoor and outdoor use. In the relevant industry, outdoor APs have custom-designed PCBs and thermal design that is more robust than indoor APs. Since indoor APs are more common and less robust, economies of scale and cheaper component costs make indoor APs much cheaper than outdoor APs. Advantageously, using techniques described in this paper, indoor AP components (e.g., PCBs) can be put into outdoor enclosures with a XOR fan array, enabling manufacturers to take advantage of economies of scale by using indoor AP components in outdoor APs.

A specific implementation of the AP with XOR fan array has a standard (indoor) PCB component, but can operate in a temperature range of −40 C to 60 C. The AP with XOR fan array implementation is specced to ambient −40 C to 50 C, but it is believed the actual operating temperature can be as high as 60 C (temperatures inside the enclosure can reach +20 C above ambient). It should be noted that ranges above 60 C ambient are exceptionally uncommon. Environmentally sealed enclosures increase the internal temperatures such that the standard PCB component would have a severely reduced lifespan if not for the thermal solution provided by the XOR fan array. Single-fan solutions also have reduced lifespans compared to XOR fan arrays because a first fan of the XOR fan array can reach the end of its lifespan, only to have a second fan of the XOR fan array start running when the first fan fails.

Another interesting characteristic of APs is that reducing weight is important. There are several reasons why weight matters with AP. One reason is that shipping costs increase. Another reason is that humans have to carry and install APs. Typical outdoor APs weigh on the order of 7 to 9 kg. Since outdoor APs are typically mounted at a high point (e.g., on a pole), this can be a significant issue. Moreover, the pole on which the outdoor AP is mounted has to hold the weight, requiring that sufficiently sturdy poles are used. Another reason is that heavier APs mounted on a pole oscillate more.

A specific implementation of the AP with XOR fan array weighs only 5 kg, and it is estimated for about 4 times the cost, the weight could be reduced to slightly over 3 kg. The reason for the reduced weight is that the techniques described in this paper enable the use of a lighter heat sink. Typical outdoor APs put on a great deal of their weight because they are mounted on metal that can serve as a heat sink. The weight is further reduced in the AP with XOR fan array by using blowers instead of traditional fans. It was found that by using blowers, which take air in from the top and blow the air straight out, a smaller form factor was possible, reducing the weight of the enclosure. Blowers are harder to spin with air flow than traditional fans, which increases their lifespan, particularly in a small enclosure, such as is used for APs. Blowers can also be effectively mounted on one side in a row without causing any degradation in adjacent blowers (e.g., due to causing the blower to spin even when it is not running), and can be packed closely together, which can further reduce the form factor of the enclosure. It should be noted that traditional fans can be made to work using the techniques described in this paper, but the weight when using more traditional fans is likely to be increased by 20 to 40%, still lighter than commercially available outdoor APs without the XOR fan array; such an implementation is given attention later.

In the example of FIG. 3, the enclosure 302, heat sink 304, and are similar to the enclosure 102, heat sink 104, and of FIG. 1, and are therefore not described here in any detail. The AP components 306 are much like the electronic components 306 of FIG. 1, but are provided as part of a specific AP implementation. The XOR blower array 308 is much like the XOR fan array 108 of FIG. 1, but is provided as an example of a specific AP implementation that explicitly uses blowers instead of traditional fans. As used in this paper, the term “fan” is intended to mean either blower or fan. Where a distinction is intended, the word blower will be used explicitly, as in the example of FIG. 3. The monitoring engine 310 is assumed in the example of FIG. 3 to obtain both temperature data and data sufficient to determine whether all fans of the XOR fan array 308 are stopped, but is otherwise much like the monitoring engine 110 of FIG. 1. The reporting engine 312 is much like the reporting engine 112 of FIG. 1, but is also coupled to the reset engine 318. The control engine 314 is much like the control engine 114 of FIG. 1, but is also coupled to the stop fan timer 316.

In the example of FIG. 3, the stop fan timer 316 is a timer that is set when the control engine 314 determines that none of the blowers of the XOR blower array 308 are running. If the timer counts down (or goes off) before the control engine 314 determines that one of the blowers of the XOR blower array 308 is running, the control engine 314 sends a control signal to cause one and only one of the blowers of the XOR blower array 308 to start running. The stop fan timer 316 is not set if the AP 300 is capable of determining whether increased heat dissipation is desirable, and the AP 300 is not in an increased heat dissipation desirable mode. Advantageously, the stop fan timer 316 causes the AP 300 to delay quickly switching on a second blower when the failure of a first blower is detected. This is advantageous because sometimes “failures” are just abnormal readings that are corrected with subsequent readings. It is also possible that a fan might fail for just a moment, but still have useful life remaining. There is relatively little risk to the AP components 306 for a short pause, such as a 10 second pause, before switching on a second blower because temperature is unlikely to rise to destructive levels in such a short period of time.

In the example of FIG. 3, the reset engine 318 can reset the AP components 306 and/or the XOR blower array 308 if a temperature reading exceeds an operational threshold. In a specific implementation, the operational threshold is 80 C (internal temperature), which is an abnormal temperature, nearing what one might expect if there is a fire. So resets are relatively uncommon under normal conditions for the specific implementation. The operational threshold could be lowered, and this would actually probably result in longer lifespan for the AP components 306. However, customers typically do not like resets; so it is believed to be more desirable to set the operational threshold at a slightly “unhealthy” level to make resets are rare as is reasonably possible. It is also possible to shut down completely, instead of reset, though this is even less popular with customers.

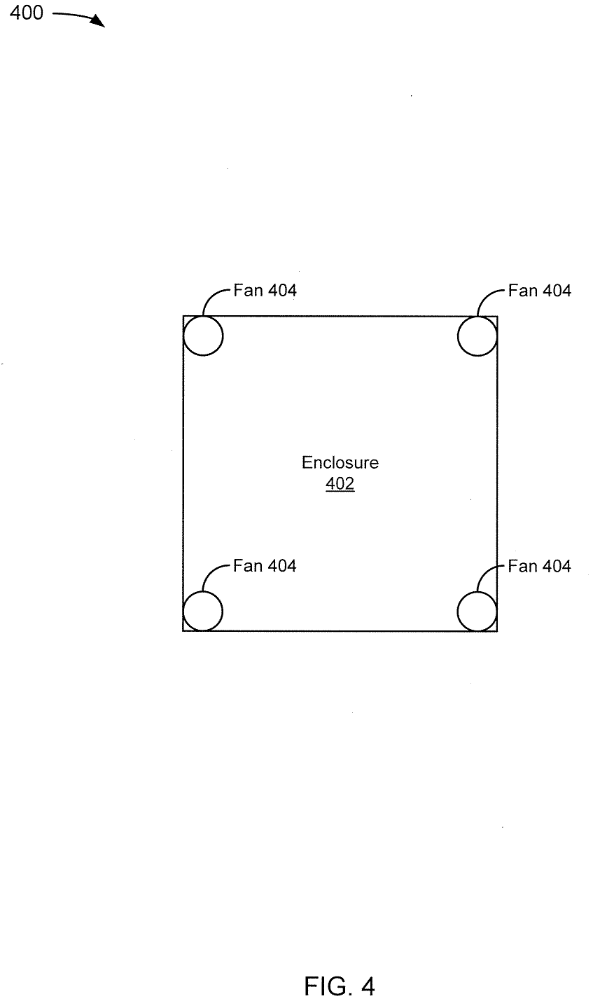

FIG. 4 depicts a conceptual diagram 400 of a corner XOR fan array configuration. The diagram 400 includes an enclosure 402 and fans 404. The fans 404 are in the corners. Experimentation for an AP form factor enclosure has shown that corners are ideal locations for fans because blockages in the enclosure 402 are typically towards the middle. It is suboptimal for a fan to work against a blockage. Also, the corners are rarely used to hold components in an AP; so it is a good place to put a fan.

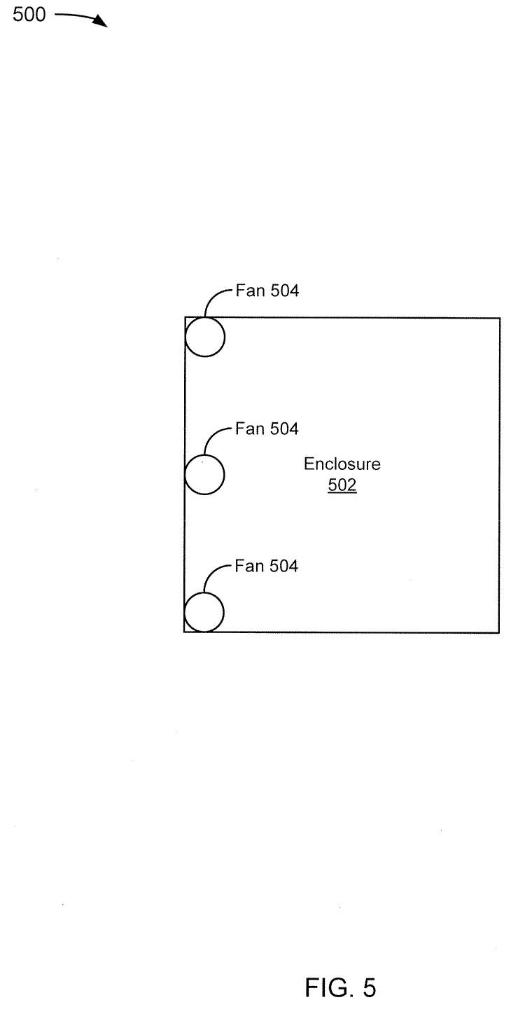

FIG. 5 depicts a conceptual diagram 500 of a side XOR fan array configuration. The diagram 500 includes an enclosure 502 and fans 504. While the side XOR fan array configuration would appear to work best with blowers, particularly because the blowers can be placed adjacent (even touching) one another, it will work with traditional fans as well. Experimentation for an AP form factor has shown that several applicable fans would work so long as they are appropriately directed. In the example of FIG. 5, the fans 504 would all be directed toward the center of the enclosure 502. In an AP form factor, the fans 504, if not blowers, should be spaced at least 5 cm from one another because this has been found to be the approximate distance at which the fans will not drive nearby fans. If the fans 504 are closer than approximately 5 cm, they tend to drive fans that are not running, reducing their expected lifespan. It is possible to put the fans 504 slightly closer together in the side XOR fan array configuration if the air from the fan is directed perpendicular to a line drawn through the center of each of the fans 504.

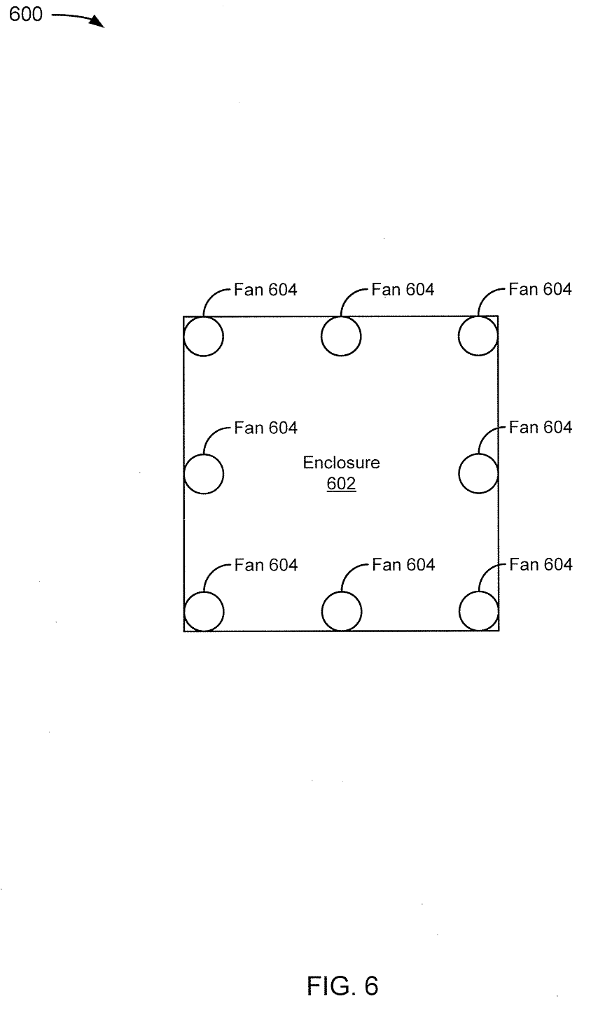

FIG. 6 depicts a conceptual diagram 600 of a full coverage XOR fan array configuration. The diagram 600 includes an enclosure 602 and fans 604. It should be noted that although a fan 604 is not in the center of the enclosure 602 (because electronic components frequently go there), the fans 604 could be evenly disbursed throughout the enclosure so long as they are properly directed and, in an AP form factor, approximately 5 cm or more from one another. The advantage of the full coverage XOR fan array is that you can put a lot of fans, which can increase the lifespan of a device. However, it is important to avoid having fans work against one another, just as it is important to avoid having fans work against a blockage. So it may not always make sense to include the maximum number of fans 604 in the enclosure 602.

Having provided 3 examples of XOR fan array configurations, it is believed one of skill in the relevant art with this reference before them would be able to make and use the teachings without undue difficulty.

It should be noted that there can be multiple XOR fan arrays in a single enclosure. For example, with reference once again to FIG. 4, the fans 404 in opposing corners could be part of first and second XOR fan arrays. However, in an AP form factor, it has been found that multiple fans do not appear to improve heat dissipation. It may be that heat dissipation is slightly improved, but that is not necessarily the case. Moreover, a single fan obviously consumes less power than multiple fans running simultaneously. In general, using the teachings provided in this paper, one could consider the air volume, fan speed, and power requirements to come up with an appropriate speed and power settings for a particular form factor.

Although techniques been described with reference to specific examples and embodiments, it will be recognized that the invention is not limited to the examples and embodiments described, but can be practiced with modification and alteration within the spirit and scope of the appended claims.

What is claimed is:

1. A system comprising:
an enclosure;
a heat sink in thermal communication with the enclosure;
electronic components at least partially sealed within the enclosure;
an eXclusive OR (XOR) fan array having a plurality of fans;
a monitoring engine coupled to the fan array;
a control engine coupled to the monitoring engine and the XOR fan array;
wherein, in operation,
the electronic components generate heat, thereby making a temperature within the enclosure higher than a temperature outside the enclosure;
the heat sink dissipates at least some heat to outside;
the monitoring engine obtains data at least sufficient to determine whether each of the plurality of fans of the XOR fan array are stopped;
the control engine determines whether each of the plurality of fans of the XOR fan array are stopped;
when each of the plurality of fans of the XOR fan array are stopped and the XOR fan array is in an increased heat dissipation desired mode, the control engine provides a control signal to the XOR fan array to cause one and only one of the plurality of fans of the XOR fan array to begin operating, and the one and only one of the plurality of fans of the XOR fan array operates to increase air flow within the enclosure, thereby increasing effectiveness of the heat sink in dissipating heat.

2. The system of claim 1, further comprising a reporting engine coupled to the monitoring engine.

3. The system of claim 1, wherein the XOR fan array is permanently set in the increased heat dissipation desired mode.

4. The system of claim 1, wherein the control engine is capable of determining whether increased heat dissipation is desired and wherein, in operation, when increased heat dissipation is desired, the control engine sets the XOR fan array to increased heat dissipation desired mode.

5. The system of claim 1, wherein the control engine is capable of determining whether decreased air flow is acceptable and wherein, in operation, when decreased air flow is acceptable, the control engine does not send the control signal to the XOR fan array to cause one and only one of the plurality of fans of the XOR fan array to begin operating.

6. The system of claim 1, wherein the control engine is capable of determining whether decreased air flow is acceptable and wherein, in operation, when decreased air flow is acceptable, the control engine provides a control signal to the XOR fan array to cause a fan of the XOR fan array to either stop operating, when the fan is currently operating, or to not begin operating, when the fan is not currently operating.

7. The system of claim 1, wherein the plurality of fans of the XOR fan array include blowers.

8. The system of claim 1, wherein the electronic components are access point (AP) components.

9. The system of claim 1, further comprising a stop fan timer coupled to the control engine, wherein, in operation, the stop fan timer is set when the control engine determines that each of the plurality of fans of the XOR fan array are stopped, and the control engine provides the control signal after the stop fan timer expires.

10. The system of claim 1, further comprising a reset engine coupled to the XOR fan array and the monitoring engine, wherein, in operation, resets the electronic components if a temperature inside the enclosure exceeds an operational threshold.

11. The system of claim 1, wherein the XOR fan array has a configuration selected from the group of configurations consisting of corner XOR fan array configuration, side XOR fan array configuration, and full coverage XOR fan array configuration.

12. The system of claim 1, wherein the XOR fan array is a first XOR fan array, further comprising a second XOR fan array.

13. A method comprising:
obtaining data at least sufficient to determine whether each of a plurality of fans of a fan array are stopped;
turning on one and only one fan when each of the plurality of fans of the fan array are stopped and increased dissipation of heat in an enclosure is desired;
controlling the fan array such that at any given time no more than one fan of the fan array is running.

14. The method of claim 13, further comprising:
generating heat inside the enclosure;
dissipating heat from within the enclosure.

15. The method of claim 13, further comprising:
turning off the one and only one fan when decreased air flow is acceptable;
controlling the fan array such that at any given time no fan of the fan array is running until increased dissipation of heat in the enclosure is desired.

16. The method of claim 13, further comprising:
treating increased dissipation of heat in an enclosure as undesirable;
setting a stop fan timer when it is determined that each of the plurality of fans of the fan array are stopped;
treating increased dissipation of heat in an enclosure as desirable when the stop fan timer expires.

17. The method of claim 13, further comprising:
determining whether a temperature in the enclosure exceeds an operational threshold;
resetting electronic components in the enclosure when the temperature in the enclosure exceeds the operational threshold.
